(19) United States
(12) Patent Application Publication
(10) Pub. No.: US 2013/0070187 A1
(43) Pub. Date: Mar. 21, 2013

(54) METHOD FOR IMPROVING VIEW ANGLE OF LCD AND LCD

(71) Applicants: Chia-chiang Hsiao, Shenzhen (CN); Chih-wen Chen, Shenzhen (CN); Chengming He, Shenzhen (CN)

(72) Inventors: Chia-chiang Hsiao, Shenzhen (CN); Chih-wen Chen, Shenzhen (CN); Chengming He, Shenzhen (CN)

(73) Assignee: Shenzhen China Star Optoelectronics Technology Co., Ltd., Shenzhen (CN)

(21) Appl. No.: 13/320,754

(22) PCT Filed: Sep. 19, 2011
(86) PCT No.: PCT/CN2011/079803

§ 371 Date: Nov. 16, 2011

(51) Int. Cl. G02F 1/1333; H01J 9/00

(52) U.S. Cl. 349/110; 445/24

(57) ABSTRACT

A method for improving a view angle of a liquid crystal display (LCD) and the LCD are disclosed. The method comprises the following steps: forming a black masking unit on a second surface of the glass substrate at a position opposite to the black photoresist, the second surface and the first surface being opposite with each other, the black photoresist and the black masking unit being disposed at two sides of the glass substrate respectively. The method for improving a view angle of an LCD and the LCD of the present invention can improve the view angle of the LCD and increase the aperture ratio; additionally, the present invention can also enhance error tolerance in assembling the quarter-wave phase difference plate with the LCD, thus reducing the reject ratio.

### BACKGROUND

1. Technical Field

The present invention relates to the field of liquid crystal displaying, and more particularly, to a method for improving a view angle of a liquid crystal display (LCD) and the LCD.

2. Description of Related Art

As is well known, in a three-dimensional (3D) LCD, light from a polarizer at a color filter (CF) side of the LCD is linearly polarized light, which then propagates through a patterned half-wave phase difference plate and an isotropic material layer to become linearly polarized light rays perpendicular to each other. After propagating through quarter-wave phase difference plate both having an included angle of 45°, the two linearly polarized light rays become a left-hand circularly polarized light ray and a right-hand circularly polarized light ray respectively, which then propagate through quarter-wave phase difference plates of the eyeglasses to become linearly polarized light rays. The linearly polarized light rays then propagate through the polarizers of the eyeglass to the left eye and the right eye respectively. Because a sheet of glass and a polarizer (having a total thickness of 0.9 mm) are sandwiched between the color filter of the LCD and the quarter-wave phase difference plates, pixels can be seen correctly when a user looks at the LCD directly in front of the LCD. However, when the user looks at the LCD from above or from below, an image from right-eye pixels will pass through the phase-difference plate in front of the left-eye pixels, so the image from the right-eye pixels that otherwise should be blocked by the eyeglass will be seen by the left eye to cause a false image. As the user looks at the LCD at a larger view angle, the percentage of the false image becomes greater and the displaying effect of the 3D image becomes poorer. Usually, in the 3D display, the 3D image will become unclear or the user will feel uncomfortable when the false image accounts for 7% of the correct image.

In order to improve the view angle, a usual practice is to increase the width of a black masking layer on the color filter so that the light of the false image that would otherwise be seen is blocked by the black masking layer. However, this leads to a decrease in the effective aperture ratio of pixels, which in turns leads to degradation in luminance of the LCD when displaying a two-dimensional (2D) or 3D image. Another practice is to provide a black masking layer on the quarter-wave phase difference plate so that light of the false image is blocked by the black masking layer. Although this can increase the aperture ratio, the black masking layer has to be additionally fabricated on the quarter-wave phase difference plate. Especially, thin-film quarter-wave phase difference plates supplied by many manufacturers in the market are quarter-wave phase difference retardation films formed directly on a thin film material, so additional use of the black masking layer on the quarter-wave phase difference plate requires additional alignment and exposure processes and a step of development carried out on the thin film, which tend to cause poor stability of the thin film.

### BRIEF SUMMARY

A primary objective of the present invention is to provide a method for improving a view angle of an LCD that can effectively improve the view angle of the LCD.

To achieve this objective, the present invention provides a method for improving a view angle of an LCD, comprising a step of forming a black photoresist and a color photoresist on a first surface of a glass substrate to form a color filter. Wherein the method further comprises the following steps:

forming a black masking unit on a second surface of the glass substrate at a position opposite to the black photoresist, the second surface and the first surface being opposite with each other, and the black photoresist and the black masking unit being disposed at two sides of the glass substrate respectively.

Preferably, the step of forming a black masking unit on a second surface of the glass substrate at a position opposite to the black photoresist further comprises: forming the black masking unit to have the same shape and the same size as the black photoresist and to be aligned with or partially staggered with the black photoresist.

Preferably, the step of forming a black masking unit on a second surface of the glass substrate at a position opposite to the black photoresist further comprises:

disposing the black masking unit on the second surface of the glass substrate according to the type of the LCD, wherein if the LCD is of a head-level type, then the black masking unit is disposed at a position aligned with the black photoresist; if the LCD is of a head-up type, then the black masking unit is disposed at a position lower than a horizontal side of the black photoresist; and if the LCD is of a head-down type, then the black masking unit is disposed at a position higher than the black photoresist.

Preferably, the step of forming a black masking unit on a second surface of the glass substrate at a position opposite to the black photoresist further comprises: forming the black photoresist and the black masking unit to be 6 micrometers (μm) to 50 μm wide.

The present invention also provides an LCD comprising a quarter-wave phase difference plate, a polarizer and a color filter in sequence. The color filter comprises a glass substrate which has a first surface and a second surface at both sides respectively, and the first surface is provided with a black photoresist and a color photoresist. A black masking unit is disposed on the second surface of the glass substrate at a position opposite to the black photoresist.

Preferably, the black photoresist and the black masking unit are 6 μm to 50 μm wide.

Preferably, the black masking unit has the same shape and the same size as the black photoresist.

Preferably, the black masking unit is disposed at a position aligned with the black photoresist.

Preferably, the black masking unit is disposed at a position lower than the black photoresist.

Preferably, the black masking unit is disposed at a position higher than the black photoresist.

The present invention further provides an LCD comprising a quarter-wave phase difference plate, a polarizer and a color filter in sequence. The color filter comprises a glass substrate which has a first surface and a second surface at both sides respectively, and the first surface is provided with a black photoresist and a color photoresist. A black masking unit is disposed on the second surface of the glass substrate at a position opposite to the black photoresist; the black masking unit has the same shape and the same size as the black photoresist; and the black photoresist and the black masking unit is 6 μm to 50 μm wide.

According to the present invention, a black masking unit is disposed on a back surface of the glass substrate to block light of the false image, so the view angle of the LCD can be improved; moreover, as this structure can reduce the width of the original black photoresist, the aperture ratio is improved. Additionally, because the black photoresist has a small width in the LCD of the present invention, error tolerance during assembly of the quarter-wave phase difference plate can be improved, thus reducing the reject ratio.

### BRIEF DESCRIPTION OF THE DRAWINGS

FIG. 1 is a flowchart diagram of a preferred embodiment of a method for improving a view angle of an LCD according to the present invention;

FIG. 2 is a schematic view of a head-level type LCD fabricated according to the method shown in FIG. 1;

FIG. 3 is a schematic view of a head-up type LCD fabricated according to the method shown in FIG. 1;

FIG. 4 is a schematic view of a head-down type LCD fabricated according to the method shown in FIG. 1;

FIG. 5 is a schematic structural view of a preferred embodiment of an LCD according to the present invention;

FIG. 6 is a schematic view illustrating assembly of a quarter-wave phase difference plate in a conventional LCD; and

FIG. 7 is a schematic view illustrating assembly of a quarter-wave phase difference plate in the LCD shown in FIG. 5.

Hereinafter, implementations, functional features and advantages of the present invention will be further described with reference to embodiments thereof and the attached drawings.

### DETAILED DESCRIPTION

It shall be understood that, the embodiments described herein are only intended to illustrate but not to limit the present invention.

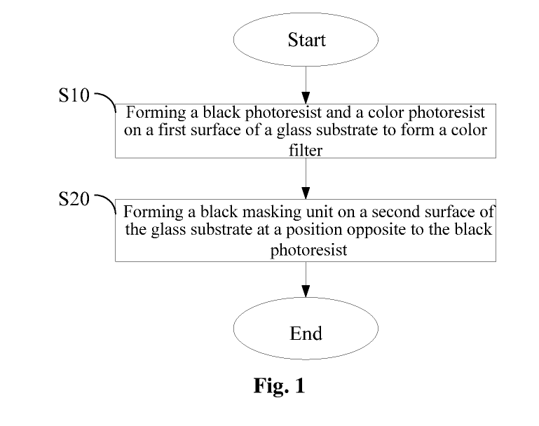

Referring to FIG. 1, there is shown a flowchart diagram of a preferred embodiment of a method for improving a view angle of an LCD according to the present invention.

In this embodiment, the method for improving a view angle of an LCD comprises the following steps.

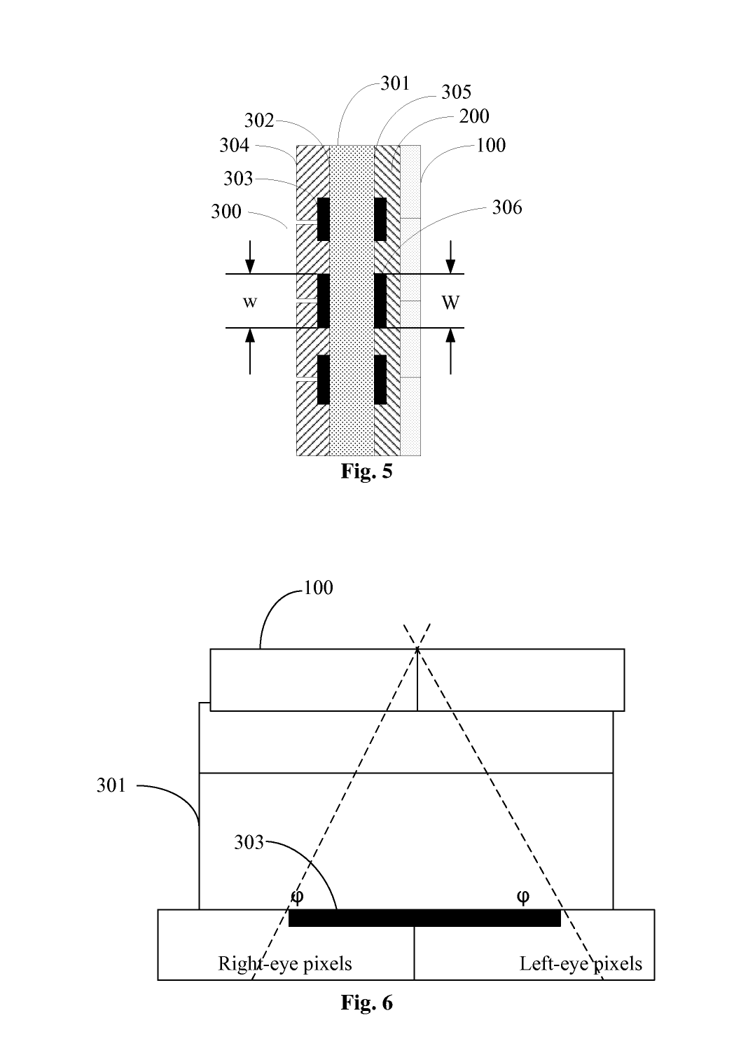

Step S10: forming a black photoresist and a color photoresist on a first surface of a glass substrate to form a color filter. In this embodiment, the LCD (i.e., a 3D phase retardation graphic LCD) comprises a color filter. The color filter is comprised of a glass substrate, a black photoresist and a color photoresist. The black photoresist and the color photoresist are coated on a surface of the glass substrate. For convenience of description, the surface coated with the black photoresist and the color photoresist is defined as a first surface, and a surface opposite to the first surface is defined as a second surface. In this step, in order to increase the aperture ratio so that the luminance of the LCD will not degrade when displaying a 2D or 3D image, the black photoresist is formed to have a width smaller than the width commonly used in the prior art. In the prior art, the black photoresist is usually 10 micrometers (μm) to 100 μm wide depending on practical needs of different LCD panels. In this embodiment, the width of the black photoresist (definition of the black photoresist will be described in a following embodiment shown in FIG. 5) may be 6 μm to 50 μm. In practical applications, the width of the black photoresist may be determined flexibly depending on the aperture ratio required. The black photoresist is formed in the form of an array on the glass substrate, with a gap existing between any two adjacent black photoresist blocks. The black photoresist may be formed in many ways, for example, through a pigment dispersion process or a transfer printing process. The color photoresist may comprise photoresist of the three primary colors (red, green and blue) which are disposed in corresponding gaps between the black photoresist blocks respectively.

Step S20: forming a black masking unit on a second surface of the glass substrate at a position opposite to the black photoresist. In this embodiment, the black photoresist and the black masking unit in each group are disposed on two sides of the glass substrate at positions corresponding to each other; that is, if the second surface of the glass substrate is used as a projection plane, then a projection of the black photoresist on the second surface along a direction perpendicular to the second surface is partially overlapped with the black masking unit. Additionally, in this embodiment, both the shape and the size of the black masking unit are substantially the same as the black photoresist. The fabrication process of the black masking unit is substantially the same as the fabrication process of the black photoresist described in step S10. For example, the black masking unit may be fabricated through a pigment dispersion process comprising the following steps:

coating a black photoresist material on the second surface of the glass substrate;

carrying out a vacuum drying process;

carrying out a pre-baking and cooling process;

disposing a photomask on the second surface for exposure, wherein the photomask is formed with a plurality of apertures for forming black masking units;

both the size and positions of the apertures are determined according to the black photoresist (for example, both the size and positions of the apertures may be the same as apertures of the photomask for forming the black photoresist); and even further, the black masking unit may be formed through the photomask for forming the black photoresist; and

carrying out a development and baking process to form black masking units overlapped with the black photoresist.

In other embodiments, the black masking unit may also be formed through screen printing or the like process.

In this embodiment, the black photoresist is reduced in width to increase the aperture ratio; however, due to the reduced width of the black photoresist, the range in which a user can see a false image when seeing a 3D image is enlarged. In order to make up for this in the LCD of the present invention, a black masking unit is disposed on the second surface of the glass substrate that is spaced apart from the black photoresist by a certain distance. Thus, light of the false image generated due to the reduced width of the black photoresist can be blocked by the black masking unit to obtain a desirable viewing effect that is equivalent to that obtained when an additional black masking layer is formed on the quarter-wave phase difference plate. Moreover, the black masking unit is disposed on the glass substrate in the present invention, so as compared to the conventional practice of forming an additional black masking layer on the quarter-wave phase difference plate, the manufacturing process becomes simpler and easier without compromising performance of the parts.

In the prior art, the practice of using a black masking layer at the color filter side to block the false image at large view angles leads to a small aperture ratio. In the embodiment of the present invention, the black masking unit and the black photoresist that are spaced apart by a certain distance are used simultaneously to block the false image. Specifically, when the LCD is displaying a 3D image and the user looks at the LCD at a large view angle, the false image will be blocked by the black masking unit so that the image from the right-eye pixels cannot pass through the quarter-wave phase difference plate in front of the left-eye pixels and the image from the left-eye pixels cannot pass through the quarter-wave phase difference plate in front of the right-eye pixels, thus achieving the function of blocking false images. In this embodiment, the effective blocking range is substantially equal to a total width of the black masking unit and the black photoresist; and when their total width is equal to the width of the black photoresist used in the conventional practice of blocking the false image by increasing the width of the black photoresist, a substantially same visual effect can be achieved.

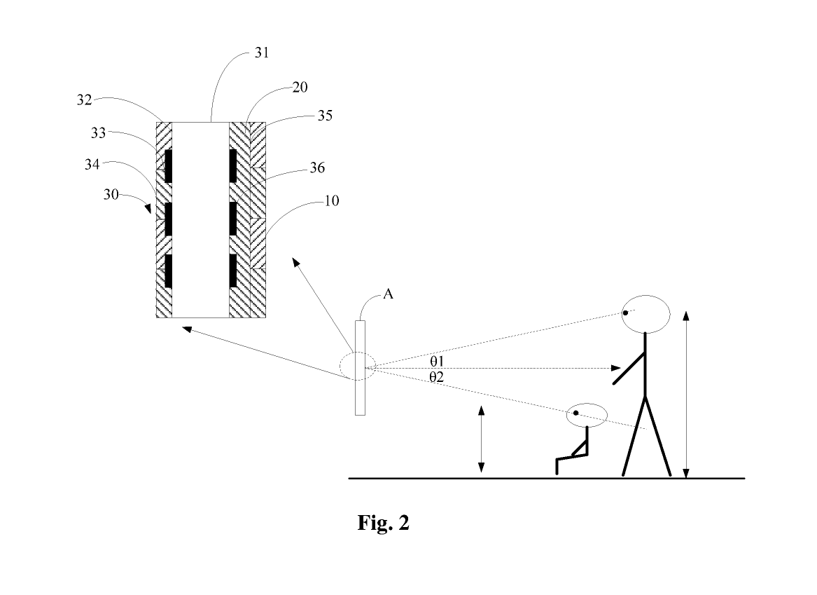

In this embodiment, the black masking unit may be disposed at a position opposite to the black photoresist, i.e., completely aligned with the black photoresist; alternatively, the black masking unit may be disposed to be partially aligned with the black photoresist. Specifically, in the embodiment of the present invention, the black masking unit is disposed on the second surface of the glass substrate in a way depending on the type of the LCD. That is, for an LCD of the head-level type, the black masking unit is disposed at a position aligned with the corresponding black photoresist. In this embodiment, both the shape and the size of the black masking unit are substantially the same as those of the black photoresist, so “aligned” as used herein means that projections of the black masking unit and the black photoresist on the second surface of the glass substrate are overlapped with each other. For an LCD of the head-up type, the black masking unit is disposed at a position lower than the black photoresist and is partially staggered with the black photoresist and, therefore, projections of them on the second surface of the glass substrate are partially overlapped with each other. For an LCD of a head-down type, the black masking unit is disposed at a position higher than the black photoresist and is partially staggered with the black photoresist and, therefore, projections of them on the second surface of the glass substrate are partially overlapped with each other. With a common viewing height (i.e., a height from the ground to the user's eyes, which is the most favorable viewing height for the user) as a reference, the LCD of the head-level type means that a horizontal height of the center of the LCD is substantially level with the common viewing height, so the user can look at the LCD horizontally; an LCD of the head-up type means that a horizontal height of the center of the LCD is higher than the common viewing height, so the user must look up at the LCD (e.g., some suspended advertisement displaying screens); and an LCD of the head-down type means that a horizontal height of the center of the LCD is lower than the common viewing height, so the user must look down at the LCD. Relative positions between the black masking unit and the black photoresist will be detailed hereinbelow with reference to FIGS. 2 to 4.

Referring to FIGS. 2 to 4, relative positions between the user and LCDs of the head-level type, the head-up type and the head-down type as well as relative positions between the black masking unit and the black photoresist in the LCDs are shown respectively. As shown in FIG. 2, with a center of the LCD A as a boundary, a top view angle θ1 is equal to a bottom view angle θ2 in this embodiment, so the user is at the common viewing position. The top view angle θ1 and the bottom view angle θ2 refer to maximum angles at which images on the display can be seen clearly from above or from below with respect to a horizontal line on the display (i.e., an imaginary horizontal line located exactly in the middle of the display).

The color filter 30 comprises a glass substrate 31. On a first surface 32 of the glass substrate 31 are disposed a black photoresist 33 and a color photoresist 34, and at the side of the second surface 35 are disposed a polarizer 20 and a quarter-wave phase difference plate 10 in sequence. On the second surface 35 is disposed a black masking unit 36 whose size is the same as the photoresist 33. The black masking unit 36 and the black photoresist 33 are disposed at two sides of the glass substrate 31 respectively and are aligned with each other; i.e., a projection of the black photoresist 33 on the second surface 35 substantially coincides with the black masking unit 36. In this case, the aperture ratio (i.e., a ratio of the light transmissive area to the total area of a unit pixel) is the greatest and the light transmissivity is also the greatest; therefore, with the backlight conditions remaining unchanged, the LCD has the highest luminance. In this embodiment of the present invention, the first surface 32 of the glass substrate refers to a side facing towards the user.

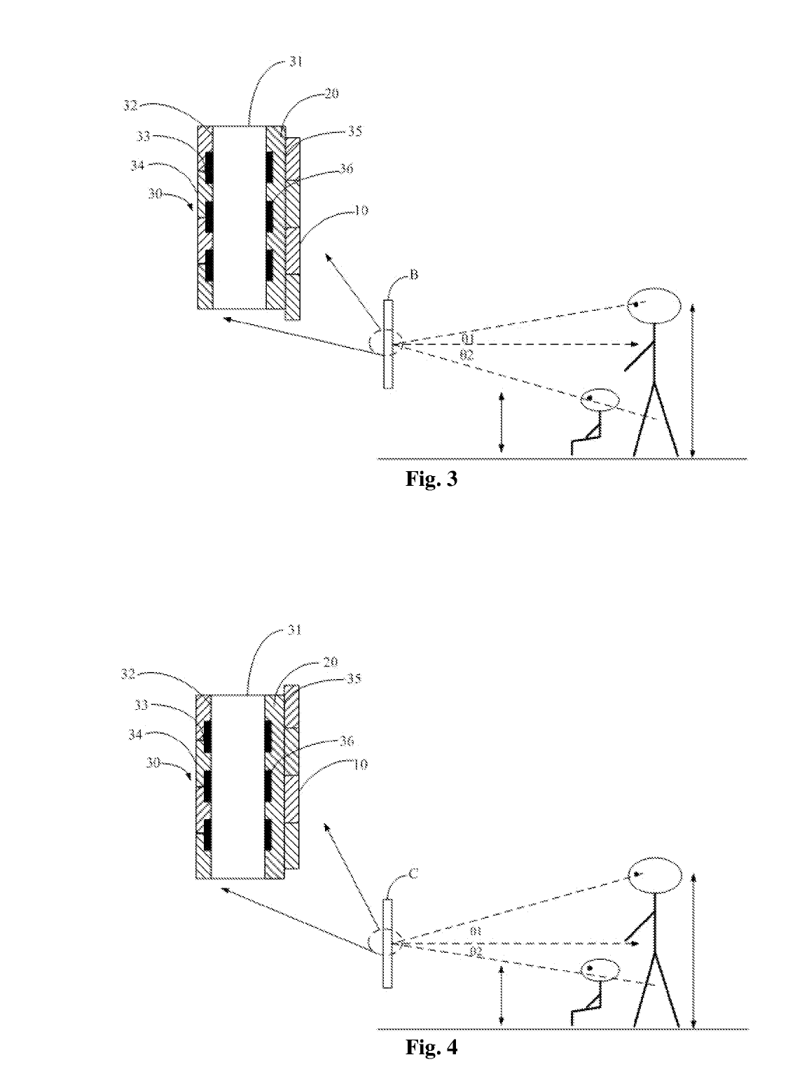

As shown in FIG. 3, for an LCD B of the head-up type whose top view angle θ1 is smaller than the bottom view angle θ2, the black masking unit 36 is disposed at a position lower than the corresponding black photoresist 33, and projections of them on the second surface are partially overlapped with each other. The offset therebetween may be determined depending on practical needs of different LCDs. Because the user will look at the LCD from below, the black masking unit 36 is shifted downwards correspondingly so that higher light transmissivity is obtained in the area covered by the bottom view angle θ2. In this way, the user can still see a correct image when looking at the LCD from below.

As shown in FIG. 4, for an LCD C of the head-down type whose top view angle θ1 is greater than the bottom view angle θ2, the black masking unit 36 is disposed at a position higher than the corresponding black photoresist 33, and projections of them on the second surface are partially overlapped with each other. Because the user will look at the LCD from above, the black masking unit 36 is shifted upwards correspondingly so that higher light transmissivity is obtained in the area covered by the top view angle θ2. In this way, the user can still see a correct image when looking at the LCD from above.

Referring to FIG. 5, there is shown a schematic structural view of an LCD fabricated by the aforesaid method.

In this embodiment, the LCD (i.e., a 3D phase retardation graphic LCD) comprises a quarter-wave phase difference plate 100, a polarizer 200 and a color filter 300 in sequence. The color filter 300 comprises a glass substrate 301, a first surface 302 of which is coated with a black photoresist 303 and a color photoresist 304. On a second surface 305 opposite to the first surface 302 is disposed a black masking unit 306 whose width W is the same as a width w of the black photoresist 303. The black masking unit 306 may be disposed to be aligned with or partially staggered with the black photoresist 303 depending on practical needs, as described in the three different embodiments shown in FIGS. 2 to 4. In order to prevent degradation in luminance of the LCD when displaying a 2D or 3D image by increasing the aperture ratio, the black photoresist 33 may be formed to have a width smaller than the width commonly used for the black photoresist in the prior art. For example, the width of the black photoresist 33 may be 6 μm to 50 μm in this embodiment. In practical applications, the width of the black photoresist may be determined flexibly depending on the aperture ratio required.

The LCD according to this embodiment of the present invention can also reduce the reject ratio of assembling quarter-wave phase difference plates with LCDs. As shown in FIG. 6, when a quarter-wave phase difference plate 100 is assembled with an LCD in the prior art, it is usually desired that a boarder between quarter-wave phase difference plates 100 of different orientations corresponds to a center of the black photoresist 303 on the color filter in order to ensure that the top view angle is equal to the bottom view angle. However, the assembling machine may cause an error of usually about 20 μm during the attachment process, which causes the boarder between the quarter-wave phase difference plates 100 to deviate from the center of the black photoresist 303. In order to keep the top view angle and the bottom view angle identical to each other, the width of the black photoresist 303 has to be increased in order to avoid light leakage due to the attachment error. This makes the aperture ratio even lower. The black photoresist 303 is spaced apart from the quarter-wave phase difference plate 100 by the glass substrate 301 having a thickness of about 700 μm. Because of the geometrical optics, when the glass become thicker, the black photoresist 303 must be made to have a larger width in order to avoid light leakage when the user looks at the LCD at a large view angle; and in order to ensure an adequate aperture ratio, the assembling error must be reduced as much as possible, but this will lead to a high reject ratio.

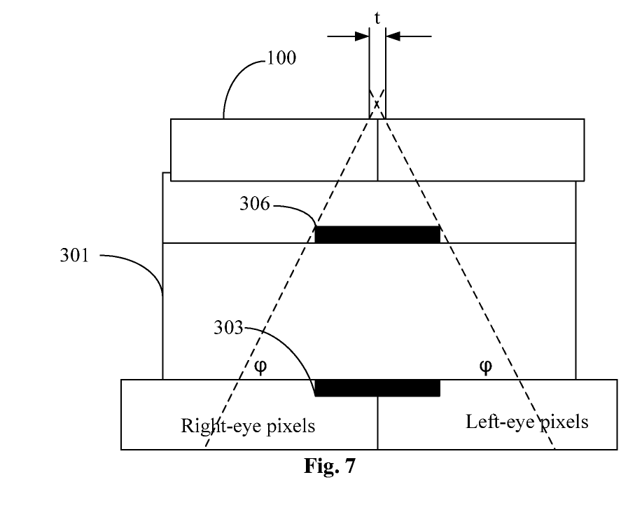

In contrast, as shown in FIG. 7, the LCD according to this embodiment of the present invention is able to increase the error tolerance in assembling by means of the black masking unit 306 on the glass substrate 301 opposite to the black photoresist 303. Between the glass substrate 301 and the quarter-wave phase difference plates 100 are a polarizer having a thickness of about 200 μm. The black masking unit 306 is disposed on the back side of the color filter glass substrate 301. Because the black masking unit 306 is very close to the quarter-wave phase difference plate 100, the influence caused by the geometrical optics is slight as long as the boarder between the quarter-wave phase difference plates 100 lies above the black masking unit 306. This greatly increases the error tolerance in the assembling process.

What described above are only preferred embodiments of the present invention but are not intended to limit the scope of the present invention. Accordingly, any equivalent structural or process flow modifications that are made on basis of the specification and the attached drawings or any direct or indirect applications in other technical fields shall also fall within the scope of the present invention.

1. A method for improving a view angle of a liquid crystal display (LCD), comprising a step of forming a black photoresist and a color photoresist on a first surface of a glass substrate to form a color filter, wherein the method further comprises the following steps:
forming a black masking unit on a second surface of the glass substrate at a position opposite to the black photoresist, the second surface and the first surface being opposite with each other, the black photoresist and the black masking unit being disposed at two sides of the glass substrate respectively.

2. The method of claim 1, wherein the step of forming a black masking unit on a second surface of the glass substrate at a position opposite to the black photoresist further comprises: forming the black masking unit to have the same shape and the same size as the black photoresist and to be aligned with or partially staggered with the black photoresist.

3. The method of claim 1, wherein the step of forming a black masking unit on a second surface of the glass substrate at a position opposite to the black photoresist further comprises:
disposing the black masking unit on the second surface of the glass substrate according to the type of the LCD, wherein if the LCD is of a head-level type, then the black masking unit is disposed at a position aligned with the black photoresist; if the LCD is of a head-up type, then the black masking unit is disposed at a position lower than a horizontal side of the black photoresist; and if the LCD is of a head-down type, then the black masking unit is disposed at a position higher than the black photoresist.

4. The method of claim 1, wherein the step of forming a black masking unit on a second surface of the glass substrate at a position opposite to the black photoresist further comprises: forming the black photoresist and the black masking unit to be 6 micrometers (μm) to 50 μm wide.

5. An LCD comprising a quarter-wave phase difference plate, a polarizer and a color filter in sequence, the color filter comprising a glass substrate which has a first surface and a second surface at both sides respectively, and the first surface is provided with a black photoresist and a color photoresist, wherein a black masking unit is disposed on the second surface of the glass substrate at a position opposite to the black photoresist.

6. The LCD of claim 5, wherein the black photoresist and the black masking unit are 6 μm to 50 μm wide.

7. The LCD of claim 5, wherein the black masking unit has the same shape and the same size as the black photoresist.

8. The LCD of claim 7, wherein the black masking unit is disposed at a position aligned with the black photoresist.

9. The LCD of claim 7, wherein the black masking unit is disposed at a position lower than the black photoresist.

10. The LCD of claim 7, wherein the black masking unit is disposed at a position higher than the black photoresist.

11. An LCD comprising a quarter-wave phase difference plate, a polarizer and a color filter in sequence, the color filter comprising a glass substrate which has a first surface and a second surface at both sides respectively, and the first surface is provided with a black photoresist and a color photoresist, wherein a black masking unit is disposed on the second surface of the glass substrate at a position opposite to the black photoresist; the black masking unit has the same shape and the same size as the black photoresist; and the black photoresist and the black masking unit are 6 μm to 50 μm wide.

12. The LCD of claim 11, wherein the black masking unit is disposed at a position aligned with the black photoresist.

13. The LCD of claim 11, wherein the black masking unit is disposed at a position lower than the black photoresist.

14. The LCD of claim 11, wherein the black masking unit is disposed at a position higher than the black photoresist.
